(19) United States
(12) Patent Application Publication
(10) Pub. No.: US 2025/0277102 A1
(43) Pub. Date: Sep. 4, 2025

(54) ANTI-FOGGING COMPOSITION AND ANTI-FOGGING PLASTICS PREPARED THEREFROM

(71) Applicant: NANO AND ADVANCED MATERIALS INSTITUTE LIMITED, HONG KONG (CN)

(72) Inventors: Xianqiao LIU, HONG KONG (CN); Fengyu YANG, HONG KONG (CN); Wei KONG, HONG KONG (CN); Dongli SUN, HONG KONG (CN)

(73) Assignee: NANO AND ADVANCED MATERIALS INSTITUTE LIMITED, HONG KONG (CN)

(21) Appl. No.: 18/592,537

(22) Filed: Mar. 1, 2024

(51) Int. Cl. C08K 5/11; C08K 5/06; C08L 23/06

(52) U.S. Cl. CPC C08K 5/11; C08K 5/06; C08L 23/06; C08K 2201/014; C08K 2201/019; C08L 2205/03; C08L 2207/04; C08L 2207/066; C08L 2310/00

(57) ABSTRACT

The present disclosure provides an anti-fogging composition, an anti-fogging plastic prepared therefrom, and related applications. Particularly, the anti-fogging composition of the present disclosure comprises a thermoplastic resin, at least one anti-fogging agent, a thermoplastic elastomer and a porous copolymer carrier. The anti-fogging plastic prepared from the anti-fogging composition of the present disclosure exhibits good mechanical properties and transparency, more durable and washable anti-fogging effect, surprisingly surface bacteria-repellent effect, low cost and easy adaption for continuous production; and meets the requirements of food contact safety, and can be widely used in the fields such as packaging, construction, medical devices and automobiles.

### BACKGROUND

### Technical Field

The present disclosure relates to the technical field of polymer materials, and particularly relates to an anti-fogging composition, an anti-fogging plastic prepared therefrom, and related applications.

### Description of Related Art

Anti-fogging plastics have been extensively used in the field of food packaging, agriculture, healthcare and daily consumer goods by giving an improvement of light transmission and reduction of water droplets to protect crop growth, and preventing pathogenic micro-organisms accumulation etc. There is an increasing demand for anti-fog products from the above industries, which is expected to grow from USD1.6 billion in 2019 to USD2.8 billion in 2027, with end-user anti-fogging products about USD200 billion.

Conventionally, the anti-fogging plastics are made by spraying or dipping hydrophilic compounds on the surface of plastics. However, the adhesion between the hydrophilic layer and hydrophobic substrates is normally very weak, resulting in only short-term anti-fogging effect and poor durability. Although it has been proposed and tried to blend hydrophilic compounds directly to polymer resins during plastic processing, there is a quick leach-out issue, due to the incompatibility between hydrophilic anti-fogging agents and polymer base resins. Someone also proposed and attempted to use amphiphilic anti-fogging agents in plastics processing to improve the compatibility of anti-fogging agents, but the porous carriers used in the prior art do not show a significant effect on the adsorption of such anti-fogging agents. In addition, an anti-fogging plastics' bacteria-repellent effect is usually achieved by adding antimicrobial agents, but the existing antimicrobial agents are mostly silver particles or quaternary ammonium cations, which would directly affect the effectiveness of the anti-fogging agents as surfactants upon addition, resulting in the disappearance or weakening of anti-fogging effect.

Thus, it is necessary to develop a new anti-fogging and bacteria-repellent composition in the art, which is more efficient and cost-effective, and can provide the plastic made by built-in technology with the advantages of more durable and washable anti-fogging property and bacteria-repellent effect.

### SUMMARY

The inventors of the present disclosure surprisingly found that an anti-fogging masterbatch can be prepared by combining an amphiphilic anti-fogging agent with at least one carrier resin comprising an elastomer and optionally a porous copolymer carrier. The as-prepared anti-fogging masterbatch not only synergistically increases the loading capacity of the anti-fogging masterbatch with anti-fogging agent(s), but also expands the loading of the anti-fogging masterbatch with different types of the anti-fogging agents. The anti-fogging plastic prepared from the anti-fogging masterbatch exhibits a significant and long-term anti-fogging effect, good washability, low cost and easy adaption for continuous production. Thus, the present disclosure is achieved.

As a first aspect of the present disclosure, provided is an anti-fogging composition comprising, based on the total weight of the anti-fogging composition:
30%-50% of a first thermoplastic resin;
25%-40% of a thermoplastic elastomer;
10%-30% of at least one anti-fogging agent; and
0%-10% of a porous copolymer carrier.

As a second aspect of the present disclosure, provided is an anti-fogging plastic prepared from the anti-fogging composition according to the first aspect and a second thermoplastic resin.

The present disclosure achieves at least one of the following beneficial effects.
(1) Introducing at least one carrier resin comprising an elastomer and optionally a porous copolymer carrier into an anti-fogging composition, e.g., an anti-fogging masterbatch not only synergistically increases the loading capacity of the anti-fogging masterbatch with anti-fogging agent(s), but also expands the loading of the anti-fogging masterbatch with different types of the anti-fogging agents. This makes it possible to simultaneously load a variety of anti-fogging agents with different properties, such as anti-fogging agents against cold fog, anti-fogging agents against hot fog, etc., thereby realizing different properties of anti-fogging plastics as needed.
(2) The anti-fogging masterbatch of the present disclosure is suitable for continuous manufacture of anti-fogging plastics, and are ready for scale-up production on existing film manufacturing line, such as extrusion film casting or blown film process without the need to improve the manufacturing line. Moreover, as compared with the base resin, the anti-fogging plastics prepared from the anti-fogging masterbatch of the present disclosure increases by only 10%-20% in cost, and are very cost-effective.
(3) The as-prepared built-in anti-fogging plastic exhibits good mechanical properties and transparency, more durable and washable anti-fogging effect, in compliance with the GB/T 31726 standard, and is suitable for repeated use and can be widely used in the fields of packaging, construction, medical equipment and automobiles. The anti-fogging plastic of the present disclosure has passed the food contact safety assessment conducted by SGS in accordance with FDA and EU regulations, and thus meets the requirements of food contact safety. More surprisingly, the anti-fogging plastic of the present disclosure exhibits a surface bacteria-repellent effect against bacterial adhesion with bacterial repellency of greater than 90% where no antimicrobial agent is added.
(4) The anti-fogging plastics of the present disclosure can exhibit both, for example, short-term and long-term anti-fogging effects, and/or both anti-fogging effect against hot fog and cold fog, due to the loading of the anti-fogging masterbatch with different kinds of anti-fogging agents.

### BRIEF DESCRIPTION OF THE DRAWINGS

The accompanying drawings are included to provide a further understanding of the disclosure and are incorporated in and constitute a part of this specification. The drawings described herein are for illustration purposes only and are not intended to limit the scope of the disclosure in any way.

FIG. 1 illustrates the general procedure for preparing the anti-fogging masterbatch pellets according to one embodiment of the present disclosure.

FIG. 2 illustrates the general procedure for preparing the anti-fogging plastic film according to one embodiment of the present disclosure.

FIG. 3 illustrates a hot fog test method by the water bath according to the Industrial standard GBT 31726 “Test method for anti-fogging property of plastic film”.

FIG. 4 illustrates the 5-grade scale according to the Industrial standard GBT 31726 “Test method for anti-fogging property of plastic film”.

FIG. 5 illustrates the results of a hot fog test by the water bath of AFPE plastic films AF08_MB #2_3% and AF08_MB #2_5% according to one embodiment of the present disclosure.

FIG. 6 illustrates the cold-fog test results of the AFPE plastic film AF03_MB #1_5% according to one embodiment of the present disclosure.

FIG. 7 illustrates the bacteria-repellent property of the AFPE plastic film AF08_MB #2_5% according to one embodiment of the present disclosure and a PE film (control) against E. coli and S. aureus.

FIG. 8A and FIG. 8B illustrate the bacteria-repellent results of the AFPE plastic film AF08_MB #2_5% according to one embodiment of the present disclosure against S. aureus (FIG. 8A) and E. coli (FIG. 8B).

FIG. 9 illustrates the Food Contact Safety Assessment report of the AFPE plastic film AF08_MB #2_5% according to one embodiment of the present disclosure conducted by SGS in accordance with FDA and EU regulations.

FIG. 10 illustrates the results of a hot fog test by the water bath of the AFPE plastic film AF_MB #1_7% according to one embodiment of the present disclosure with and without 100 times wash.

### DESCRIPTION OF THE EMBODIMENTS

The following detailed description is merely exemplary in nature and is in no way intended to limit the present disclosure or its application or uses.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The terminology used herein is for the purpose of describing particular example embodiments only and is not intended to be limiting.

As used herein, “a”, “an”, “the”, “at least one” and “one or more” are used interchangeably to indicate that at least one of the specified elements, materials, ingredients or method steps is present, unless the context clearly indicates otherwise.

As used herein, the terms “about” and “substantially” are used herein with respect to measurable values and ranges due to expected variations known to those skilled in the art (e.g., limitations and variability in measurements). The term “about” also indicates that the stated numerical value allows some slight imprecision (with some approach to exactness in the value; approximately or reasonably close to the value; nearly). If the imprecision provided by the term “about” is not otherwise understood in the art with this ordinary meaning, then the term “about” as used herein indicates at least variations that may arise from ordinary methods of measuring and using such parameters. In addition, disclosure of ranges includes disclosure of all values and further divided ranges within the entire range.

As used herein, the term “including”, “containing” and the like terms, together with their grammatical variations, are synonymous with the term “comprising” and its grammatical variations. The term “comprising” and its grammatical variations are open-ended and shall be understood in the context of the present disclosure to include not only the specified elements, materials, ingredients or method steps, but also additional unspecified elements, materials, ingredients or method steps.

As used herein, the term “consisting of” and its grammatical variations should be understood in the context of the present disclosure to exclude the presence of any unspecified element, ingredient or method step. As used herein, the term “consisting essentially of” and its grammatical variations should be understood in the context of the present disclosure to include the specified elements, materials, ingredients or method steps and those that do not materially affect the basic and novel characteristic(s) of what is being described. It shall be understood that, when the term “comprising” and its grammatical variations are used and no additional elements, materials, ingredients or method steps that may materially affect the basic and novel characteristic(s) of what is being described are included, then the term “comprising” can be replaced with the term “consisting of” or “consisting essentially of” and their grammatical variations.

In the context of the present disclosure, each component is given in a weight percentage.

Whereas specific aspects of the disclosure is going to be described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

As mentioned above, the present disclosure aims to provide an anti-fogging composition, and the anti-fogging plastic prepared from the anti-fogging composition exhibits significant and long-term anti-fogging effect, good washability, surface bacteria-repellant effect and low cost and is suitable for continuous production.

As a first aspect of the present disclosure, provided is an anti-fogging composition, comprising, based on the total weight of the anti-fogging composition:
30%-50% of a first thermoplastic resin;
25%-40% of a thermoplastic elastomer;
10%-30% of at least one anti-fogging agent; and
0%-10% of a porous copolymer carrier.

### Thermoplastic Resin

In the context of the present disclosure, the term “thermoplastic resin” refers to a polymer that softens to a liquid when heated and cures when cooled, but is not subjected to a chemical reaction.

The first thermoplastic resin in the anti-fogging composition of the present disclosure may be materials of general plastics, such as polyethylene (PE), polypropylene (PP), ethylene vinyl acetate (EVA), and polyvinyl chloride (PVC), so that it can be applied to the general plastic masterbatch to make an anti-fogging plastic.

In a particular embodiment, the first thermoplastic resin may be one or more selected from the group consisting of polyethylene (PE), polypropylene (PP), ethylene vinyl acetate (EVA) and polyvinyl chloride (PVC).

In a particular embodiment, the polyethylene (PE) has a weight average molecular weight of 40,000-120,000 (Mw); the polypropylene (PP) has a weight average molecular weight of 80,000-150,000; the ethylene vinyl acetate (EVA) has a weight average molecular weight of 20,000-50,000; and the polyvinyl chloride (PVC) has a weight average molecular weight of 50,000-110,000.

In a preferred embodiment, the first thermoplastic resin may be the polyethylene (PE).

In a more preferred embodiment, the first thermoplastic resin may be low-density polyethylene (LDPE).

In the context of the present disclosure, the term “low-density polyethylene (LDPE)” refers to a polyethylene having a density range from 0.910 to 0.940 g/cm3.

In a particular embodiment, the first thermoplastic resin is present in an amount from about 35% to about 45%, based on the total weight of the anti-fogging composition. For example, it may be present at an amount of about 35%, 36%, 37%, 38%, 39%, 40%, 41%, 42%, 43%, 44% or 45%, or in any range composed of the above numbers, based on the total weight of the antifogging composition.

In a preferred embodiment, the first thermoplastic resin may be present in an amount from about 35% to about 40%, based on the total weight of the anti-fogging composition.

### Anti-Fogging Agent

As used in the present disclosure, the anti-fogging agent used in the anti-fogging composition of the present disclosure is an amphipathic compound, comprising a super-hydrophilic segment with anti-fogging function and a hydrophobic segment that is compatible with a plastic base (i.e., a polymer matrix) suitable for the manufacture of anti-fogging plastics. The super-hydrophilic segment may be, for example, but not limited to, a group having multiple-OH end groups (e.g., ethylene oxide), and is capable of reducing the surface tension of the anti-fogging plastic so that the moisture can migrate to the surface of the plastic to form a water layer or a hydrated layer, preventing the formation of fogdrop and biofilms on the surface, and preventing adherence, growth and reproduction of bacteria on the surface of the plastic. The hydrophobic segment may be, for example, C12-C14 alkyl ether that is highly compatible with the polymer matrix.

In a particular embodiment, the at least one anti-fogging agent may be present in an amount from about 15% to about 30%, based on the total weight of the anti-fogging composition. For example, it may be at an amount of about 15%, 16%, 17%, 18%, 19%, 20%, 21%, 22%, 23%, 24%, 25%, 26%, 27%, 28%, 29% or 30%, or in any range composed of the above numbers, based on the total weight of the anti-fogging composition.

In a preferred embodiment, the at least one anti-fogging agent may be present in an amount from about 20% to about 30%, based on the total weight of the antifogging composition.

In a particular embodiment, the at least one anti-fogging agent may be an amphipathic compound with multiple-OH end groups and a long-chain hydrophobic aliphatic group.

In a preferred embodiment, the at least one anti-fogging agent may be selected from the group consisting of fatty glyceride such as glyceryl stearate, glycerol monooleate; fatty alcohol polyoxyethylene ether, such as polyoxyethylene lauryl ether; alcohol oleate; sorbitan monostearate; polyether oligomer, such as propylene glycol, polyethylene glycol, and octadecyldiethanolamine. Among the above anti-fogging agents, fatty glyceride is a long-term anti-fogging agent that can provide a long-term anti-fogging property; and polyoxyethylene lauryl ether is a short-term anti-fogging agent that can provide an instant or short-term anti-fogging property.

In a more preferred embodiment, the at least one anti-fogging agent may be fatty glyceride and/or fatty alcohol polyoxyethylene ether.

In a most preferred embodiment, the at least one anti-fogging agent may be the fatty glyceride of formula I, or polyoxyethylene lauryl ether of formula II:

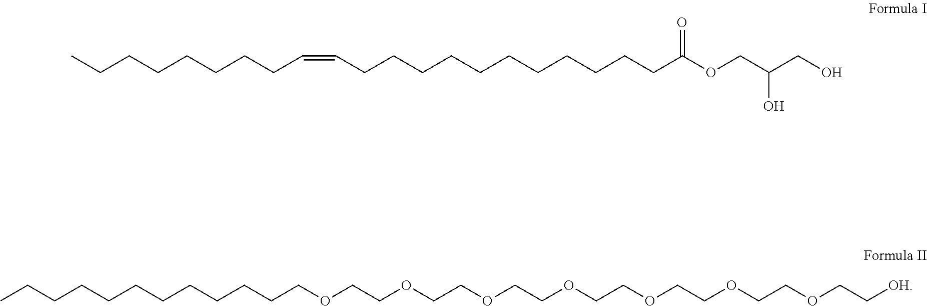 [SMILES: CCCCCCCC/C=C\CCCCCCCCCCCC(=O)OCC(O)CO ; CCCCCCCCCCCCOCCOCCOCCOCCOCCOCCOCCO]

As used in the present disclosure, the anti-fogging agent may comprise a combination of two or more anti-fogging agents. The two or more anti-fogging agents, upon combination, may each have different anti-fogging properties, and thus can provide complementary or full range anti-fogging effects. For example, a short-term anti-fogging agent, e.g., polyoxyethylene lauryl ether, and a long-term anti-fogging agent, e.g., a fatty glyceride, can be loaded together to provide both instant and long-term anti-fogging effects. As another example, an anti-fogging agent against cold fog, e.g., a fatty glyceride, and an anti-fogging agent against hot fog, e.g., polyoxyethylene dodecyl ether, can be loaded together to provide effect of preventing both hot fog and cold fog from formation. It would be understood that an anti-fogging agent can possess different anti-fogging properties at the same time. For example, the fatty glyceride possesses a long-term anti-fogging property and an anti-fogging property of preventing cold fog from formation. Again for example, the polyoxyethylene dodecyl ether possesses an instant anti-fogging property and an anti-fogging property of preventing hot fog from formation. When the two anti-fogging agents are used in combination, the full range anti-fogging requirements for plastics can be realized.

In a preferred embodiment, the anti-fogging composition comprises a combination of fatty glyceride and fatty alcohol polyoxyethylene ether.

### Thermoplastic Elastomer

In the context of the present disclosure, the term “thermoplastic elastomer” refers to an elastomer material that exhibits the elasticity of rubber at room temperature and can be plasticized at a high temperature. As used herein, a thermoplastic elastomer is introduced into the anti-fogging composition and can provide swelling adsorption due to its rigid-soft-rigid structure, so that it can load the added anti-fogging agents by adsorption, thereby significantly increasing the amount of the anti-fogging agents as loaded, and at the same time improving the process conditions for preparing anti-fogging plastics from the anti-fogging masterbatch.

In a particular embodiment, the thermoplastic elastomer may be present in an amount from about 30% to about 35%, based on the total weight of the anti-fogging composition. For example, it may be at an amount of about 30%, 31%, 32%, 33%, 34% or 35% by weight, or in any range composed of the above numbers, based on the total weight of the anti-fogging composition.

In a particular embodiment, the thermoplastic elastomer used in the anti-fogging composition of the present disclosure may be selected from the group consisting of ethylene-octene copolymer (POE), ethylene-propene-diolefin copolymer (EPDM), styrene-butadiene-styrene block copolymer (SBS), styrene-ethylene-butylene-styrene block copolymer (SEBS), and styrene-ethylene-propylene block copolymer-styrene (SEPS).

In a preferred embodiment, the thermoplastic elastomer aid may be styrene-ethylene-butylene-styrene block copolymer (SEBS).

### Porous Copolymer Carrier

Those skilled in the art would understand that a porous copolymer carrier can bind to anti-fogging agents via adsorption to load the anti-fogging agents.

In a particular embodiment, the porous copolymer carrier may be present in an amount from about 3% to about 7%, based on the total weight of the anti-fogging composition. For example, it may be at an amount of about 3%, 4%, 5%, 6% or 7% by weight, or in any range composed of the above numbers, based on the total weight of the anti-fogging composition.

In a particular embodiment, the porous copolymer carrier used in the anti-fogging composition of the present disclosure may be selected from the group consisting of an ethylene butyl acrylate (EBA) based porous copolymer carrier, a linear low-density polyethylene (LLDPE) based porous copolymer carriers, and a low-density polyethylene (LDPE) based porous copolymer carrier.

In a preferred embodiment, the porous copolymer carrier is a low-density polyethylene (LDPE) based porous copolymer carrier.

### Anti-Fogging Composition

In a particular embodiment, the anti-fogging composition may be in a form of an anti-fogging masterbatch.

In a further particular embodiment, the anti-fogging composition may be prepared by mixing the first thermoplastic resin, the at least one anti-fogging agent, the thermoplastic elastomer and the porous copolymer carrier at a defined weight ratio and extruding through a twin-screw extruder. More particularly, the anti-fogging agent, the thermoplastic elastomer and the porous copolymer carrier can be mixed thoroughly first to form a first mixture. Then, the first mixture is mixed thoroughly with the first thermoplastic resin to obtain a second mixture. After that, the second mixture is loaded into a twin-screw extruder with a screw speed of, e.g., 200-600 rpm and compounded at a processing temperature of 110° C. to 200° C. (e.g., 150° C. to 190° C.). Finally, the compounded materials are pelleted.

The anti-fogging masterbatch of the present disclosure is suitable for continuous manufacture of anti-fogging plastics, and are ready for scale-up production on existing film manufacturing line, such as extrusion film casting or blown film process without the need to improve the manufacturing line. Moreover, as compared with the base resin, the anti-fogging plastics prepared from the anti-fogging masterbatch of the present disclosure increases by only 10%-20% in cost, and are very cost-effective.

Those skilled in the art can improve the above preparation method according to the actual needs without affecting the performance of the final product, and the anti-fogging masterbatch pellets prepared from the improved method do not exceed the scope of the present disclosure.

As a second aspect of the present disclosure, provided is an anti-fogging plastic prepared from the anti-fogging composition according to the first aspect and a second thermoplastic resin.

In a particular embodiment, the anti-fogging composition may be added in an amount from 1% to 10%, based on the total weight of the anti-fogging plastic.

In a more particular embodiment, the anti-fogging composition may be added in an amount from 3% to 8%, e.g., 3%, 4%, 5%, 6%, 7% or 8% by weight, or in any range composed of the above numbers, based on the total weight of the anti-fogging plastic.

In a preferred embodiment, the anti-fogging composition may be added no more than 5%, based on the total weight of the anti-fogging plastic.

In a more preferred embodiment, the anti-fogging composition may be added in an amount from 3% to 5%, based on the total weight of the anti-fogging plastic.

In a further particular embodiment, the anti-fogging composition exhibits a surface bacteria-repellent effect against bacterial adhesion with bacterial repellency of greater than 90%. The bacteria may be, but not limited to, e.g., E. coli and S. aureus.

In a further particular embodiment, the second thermoplastic resin may be selected from the group consisting of polyethylene (PE), polypropylene (PP), Ethylene Vinyl Acetate (EVA) and polyvinyl chloride (PVC).

In a more particular embodiment, the polyethylene (PE) has a weight average molecular weight of 40,000-120,000 (Mw); the polypropylene (PP) has a weight average molecular weight of 80,000-150,000; the Ethylene Vinyl Acetate (EVA) has a weight average molecular weight of 20,000-50,000; and the polyvinyl chloride (PVC) has a weight average molecular weight of 50,000-110,000.

In a preferred embodiment, the second thermoplastic resin may be polyethylene (PE).

In a more preferred embodiment, the second thermoplastic resin may be low-density polyethylene (LDPE).

In a more preferred embodiment, the second thermoplastic resin may be the same as the first thermoplastic resin, so that the anti-fogging masterbatch prepared from the anti-fogging composition of the present disclosure can be well compatible with the second thermoplastic resin (i.e., the base plastic resin).

The anti-fogging plastic of the present disclosure may be made into various forms such as sheets, films, etc. as desired. The preparation of the anti-fogging plastic from the anti-fogging composition of the present disclosure and the second thermoplastic resin may be performed by a method well-known to those skilled in the art. For example, in the case of preparing an anti-fogging plastic film, a built-in anti-fogging plastic film may be obtained by premixing the anti-fogging composition and the second thermoplastic resin at a defined weight ratio, extruding and blowing film by a twin-screw extruder. Those skilled in the art can improve the above preparation method according to the actual needs without affecting the performance of the final product, and the anti-fogging plastic product prepared from the improved method will not exceed the scope of the present disclosure.

The anti-fogging plastic of the present disclosure exhibits good mechanical properties and transparency and more durable and washable anti-fogging effect, in compliance with the GB/T 31726 standard, and is suitable for repeated use and can be widely used in the fields of packaging, construction, medical equipment and automobiles. The anti-fogging plastic of the present disclosure has passed the food contact safety assessment conducted by SGS in accordance with FDA and EU regulations, and thus meets the requirements of food contact safety. More surprisingly, the anti-fogging plastic of the present disclosure exhibits a surface bacteria-repellent effect with bacterial repellency of greater than 90% where no antimicrobial agent is added.

### EXAMPLES

Within this specification, examples have been described in a way which enables a clear and concise specification to be written, but it is intended and will be appreciated that examples may be variously combined or separated without parting from the disclosure. For example, it will be appreciated that all preferred features described herein are applicable to all aspects of the disclosure described herein.

### Example 1: Preparation of the Anti-Fogging Composition Comprising a Single Anti-Fogging Agent

The anti-fogging masterbatch pellets comprising only one anti-fogging agent were prepared through a twin-screw compounding process according to the weight ratios shown in Table 1 below, wherein anti-fogging agent 1 (AF03) is a glycerol monooleate (paste), anti-fogging agent 2 (AF04) is a fatty glyceride shown in the compound of Formula I (paste), and anti-fogging agent 3 (AF08) is a polyoxyethylene lauryl ether (liquid) shown in the compound of Formula II:

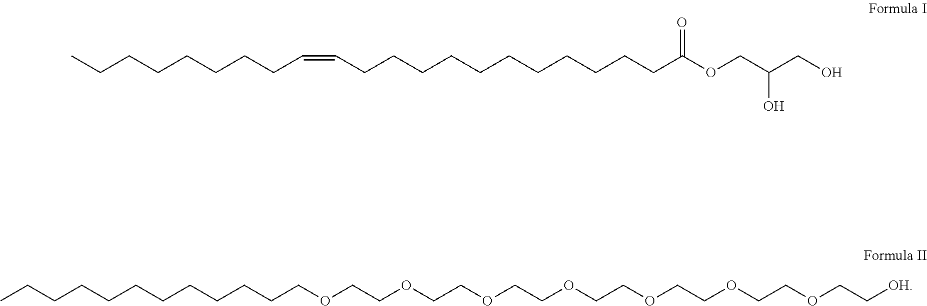 [SMILES: CCCCCCCC/C=C\CCCCCCCCCCCC(=O)OCC(O)CO ; CCCCCCCCCCCCOCCOCCOCCOCCOCCOCCOCCO]

The reagents employed in the embodiments are commercially available, for example, the low-density polyethylene (LDPE) was purchased from BASF LLC (with a Mw of 94000), and the low-density polyethylene based porous copolymer carrier (porous PE) was purchased from Graft Polymer LTD.

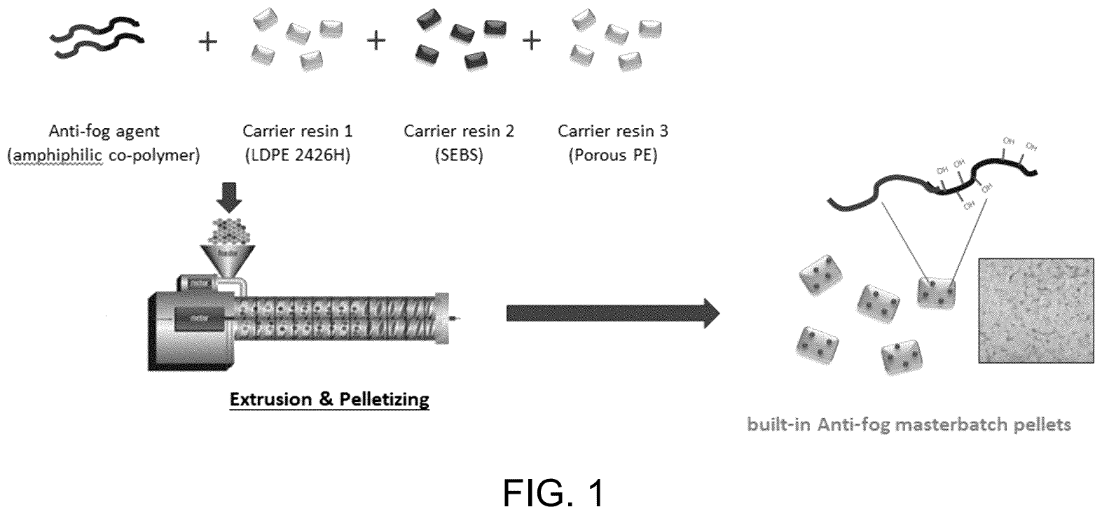

The general procedure for preparing the anti-fogging composition of the present disclosure is as follows. Firstly, the antifogging agent, thermoplastic elastomer (if any), and porous copolymer carrier (if any) were thoroughly mixed to provide a first mixture. Then, the first mixture was thoroughly mixed with the low-density polyethylene (LDPE) pellets using a high-speed mixer. Finally, all of the well-mixed materials were placed into a twin-screw extruder with a screw speed of 200 rpm at a processing temperature ranging from 150° C. to 190° C. (as shown in FIG. 1). After pelletizing, the anti-fogging masterbatch (AFMB) pellets were dried and stored at room temperature.

TABLE 1
The formulas of the anti-fogging masterbatch comprising a single anti-fogging agent

| | LDPE | SEBS | Porous | AF agent | AF agent | AF agent | |
|---|---|---|---|---|---|---|---|
| Sample ID | (wt %) | (wt %) | PE (wt %) | 1 (wt %) | 2 (wt %) | 3 (wt %) | Results |
| AF03_MB#1 | 40 | 30 | | 30 | | | Homogeneous, |
| | | | | | | | no leach-out |
| AF04_MB#1 | 40 | 30 | | | 30 | | Homogeneous, |
| | | | | | | | no leach-out |
| AF08_MB#1 | 40 | 30 | | | | 30 | Homogeneous, |
| | | | | | | | no leach-out |
| AF08_MB#2 | 35 | 30 | 5 | | | 30 | Homogeneous, |
| | | | | | | | no leach-out |
| AF08_MB#3 | 50 | 30 | | | | 20 | Homogeneous, |
| | | | | | | | no leach-out |
| AF08_MB#4 | 40 | | 30 | | | 30 | Serious leach-out |
| AF08_MB#5 | 35 | | 25 | | | 40 | Serious leach-out |

As can be seen from the results in Table 1, compared to the porous PE, the use of SEBS effectively increases the absorption of the anti-fogging agent in the anti-fogging masterbatch, thereby improving the processability of the anti-fogging masterbatch. In the following tests, it was found that the combination of SEBS and porous PE such as AF08_MB #2 exhibited synergistic effects and best processability (see below).

### Example 2: Preparation of the Anti-Fogging Composition Comprising Two Anti-Fogging Agents

The anti-fogging masterbatch pellets comprising two anti-fogging agents were prepared through a twin-screw compounding process according to the defined weight ratio shown in Table 2 below. The preparation method of the anti-fogging masterbatch pellets comprising two anti-fogging agents were similar to that of the anti-fogging masterbatch pellets comprising a single anti-fogging agent, except that two anti-fogging agents were added.

TABLE 2
The formulas of the anti-fogging masterbatch comprising two anti-fogging agents

| | LDPE | SEBS | AF agent 1 | AF agent 3 | |
|---|---|---|---|---|---|
| Sample ID | (wt %) | (wt %) | (wt %) | (wt %) | Results |
| AF_MB#1 | 50 | 30 | 10 | 10 | Homogeneous, no |
| | | | | | leach-out |
| AF_MB#2 | 50 | 30 | 15 | 5 | Homogeneous, no |
| | | | | | leach-out |
| AF_MB#3 | 50 | 30 | 5 | 15 | Homogeneous, no |
| | | | | | leach-out |

As can be seen from the results in Table 2, due to the use of the thermoplastic elastomer SEBS as a carrier for the anti-fogging agent, the anti-fogging agent 1 and the anti-fogging agent 3 could be used in combination to prepare the anti-fogging masterbatch. SEBS could efficiently adsorb the combination of the two kinds of the anti-fogging agents and improve the processability of the anti-fogging masterbatch.

### Example 3: Preparation of AFPE Plastic Film and Anti-Fogging Test

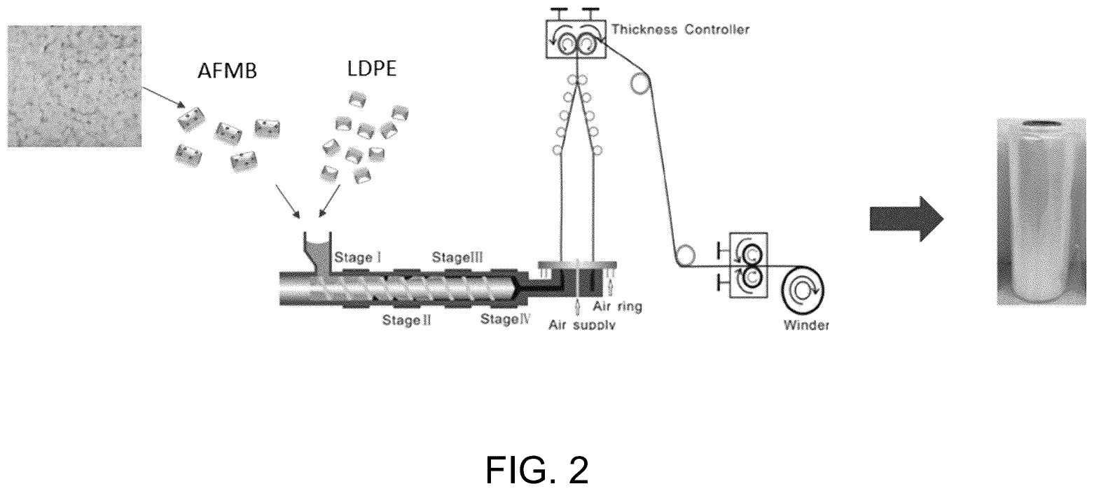

According to the defined weight ratio shown in Table 3 below, anti-fogging polyethylene (AFPE) plastic films were prepared from low-density polyethylene resin (LDPE) and the anti-fogging masterbatch (AFMB) pellets prepared in Example 1 by the blown-film extrusion method. The general process is shown in FIG. 2, wherein the extruding step was divided into four stages corresponding to the extruding temperatures of 80° C., 180° C., 190° C. and 180° C., respectively, and at a screw speed of 110 rpm.

After the film preparation, the above AFPE plastic films were tested for their anti-fogging effects according to the industrial standard GBT 31726 “Test method for anti-fogging property of plastic film”. The tests comprised a hot fog test by water bath and a cold fog test.

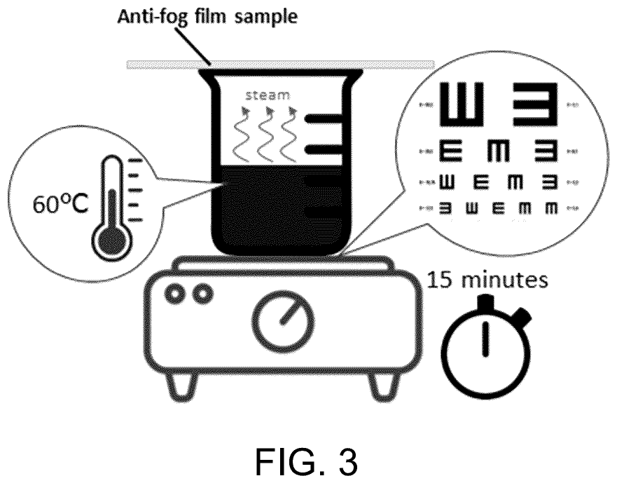

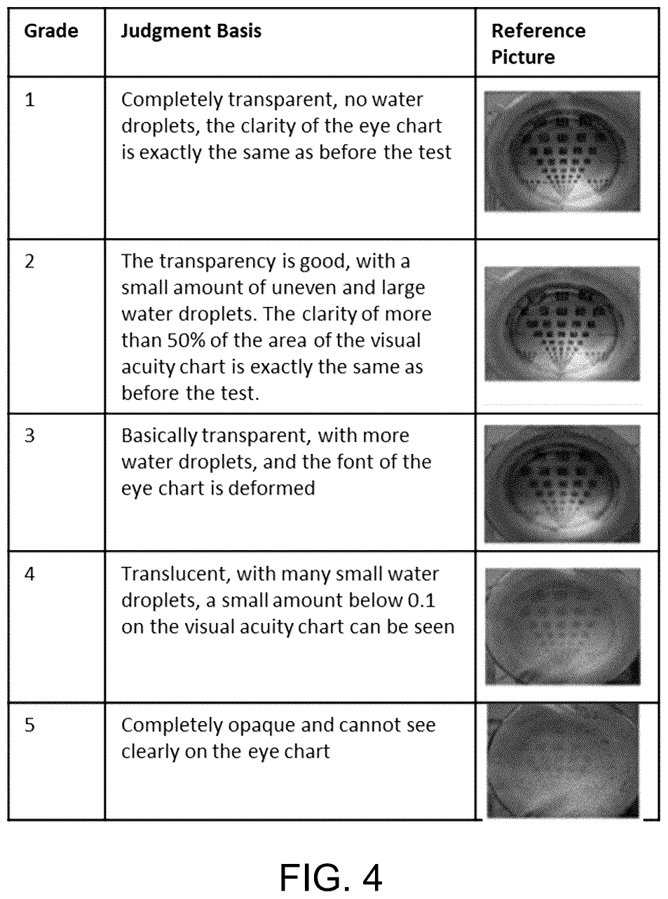

FIG. 3 shows a hot fog test by the water bath according to the Industrial standard GBT 31726. FIG. 4 shows the 5-grade scale according to the Industrial standard GBT 31726. The test condition for the hot fog test was 60° C. for 15 minutes. Particularly, the AFPE plastic films (e.g. 120 mm*120 mm, 0.6 mm thick) were put on a glass beaker (e.g. 250 mL) with hot water inside (e.g. 60° C.). A logarithmic visual acuity chart was placed at the bottom of the beaker. After 15 minutes, the anti-fogging property was evaluated through the comparison of the clarity of the chart between the vertically observed result and the images in the anti-fogging grade table.

A cold fog test was also performed on the AFPE plastic films prepared in Example 3 according to the Industrial standard GB/T 31726. The test condition for the cold fog test process was 3° C. for 5 minutes. Particularly, the AFPE plastic films were put on a glass beaker containing level 3 water at 23° C. according to GB/T 6682-2008, and then placed in a chamber or freezer at a constant temperature of 3° C. and at a constant humidity for 5 minutes. Then, the visual acuity chart at the bottom of the beaker was observed.

In addition, a 100 times washing test was conducted through a dishwasher, and the automatic washing program was set as 100 times cycle. The AFPE plastic films were rinsed at room temperature using detergent-free tap water. The results are given in Table 3.

TABLE 3
The formulas and the anti-fogging
test results of AFPE plastic films

| | LDPE | AFMB | AF grade | AF grade |
|---|---|---|---|---|
| Sample ID | (wt %) | (wt %) | (hot fog test) | (after 100 times wash) |
| Control LDPE | 100 | 0 | G5 (n = 3) | G5 (n = 3) |
| AF03_MB#1 | 97 | 3 | G4 (n = 3) | G4 (n = 3) |
| AF03_MB#1 | 95 | 5 | G3 (n = 3) | G4 (n = 3) |
| AF03_MB#1 | 90 | 10 | G4 (n = 3) | G3 (n = 3) |
| AF04_MB#1 | 97 | 3 | G3 (n = 3) | G3 (n = 3) |
| AF04_MB#1 | 95 | 5 | G3 (n = 3) | G3 (n = 3) |
| AF04_MB#2 | 90 | 10 | G3 (n = 3) | G3 (n = 3) |
| AF08_MB#1 | 97 | 3 | G3 (n = 3) | G3 (n = 3) |
| AF08_MB#1 | 95 | 5 | G2+ (n = 3) | G2+ (n = 3) |
| AF08_MB#1 | 90 | 10 | G2+ (n = 3) | G2+ (n = 3) |
| AF08_MB#2 | 97 | 3 | G2+ (n = 3) | G2+ (n = 3) |
| AF08_MB#2 | 95 | 5 | G2+ (n = 3) | G2+ (n = 3) |
| AF08_MB#2 | 90 | 10 | G4 (n = 3) | G2+ (n = 3) |

As can be seen from the results in Table 3 above, the anti-fogging property of the anti-fogging plastic films varied with the amount of the anti-fogging masterbatch as added. The AFPE plastic films, AF08_MB #1_5% (having anti-fogging masterbatch AF08_MB #1 at 5% by weight), AF08_MB #1_10% (having anti-fogging masterbatch AF08_MB #1 at 10% by weight), AF08_MB #2_3% (having anti-fogging masterbatch AF08_MB #2 at 3% by weight) and AF08_MB #2_5% (having anti-fogging masterbatch AF08_MB #2 at 5% by weight), exhibited instant and washable anti-fogging property. The anti-fogging grades of these anti-fogging plastic films all reached G2+ according to the hot fog test by the water bath in Industrial standard GB/T 31726.

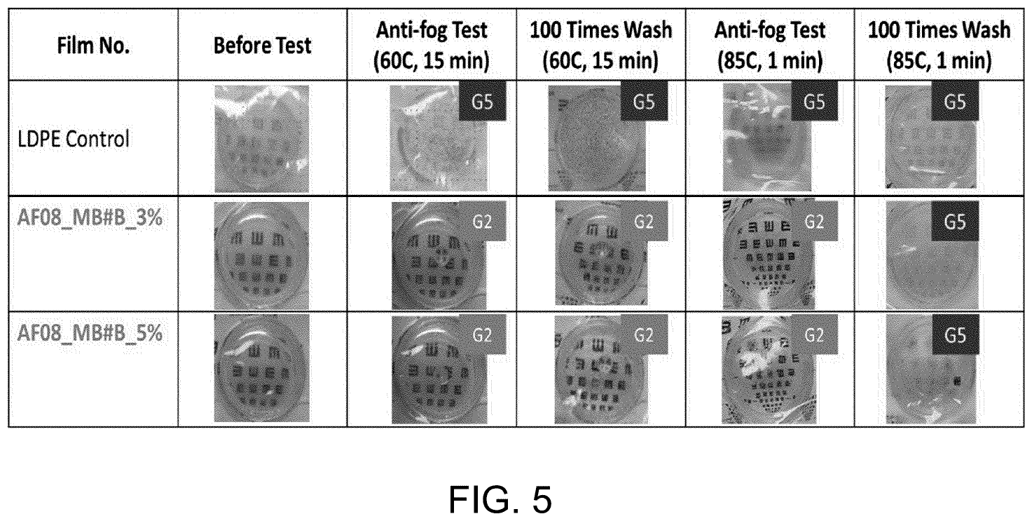

On this basis, a rapid hot-fog test according to Industrial standard GB/T 31726 was also conducted on the AFPE plastic films AF08_MB #2_3% (AF08_MB #B_3%) and AF08_MB #2_5% (AF08_MB #B_5%), which both showed excellent properties in the above-mentioned anti-fogging test, under a more severe condition (85° C. for 1 minute), and LDPE was taken as control. The results are shown in FIG. 5.

As can be seen from FIG. 5, the AFPE plastic films AF08_MB #2_3% and AF08_MB #2_5% of the present disclosure were able to maintain anti-fogging standard grade 2 (G2) after being placed at 85° C. for 1 minute, and showed high temperature-resistant anti-fogging capability.)

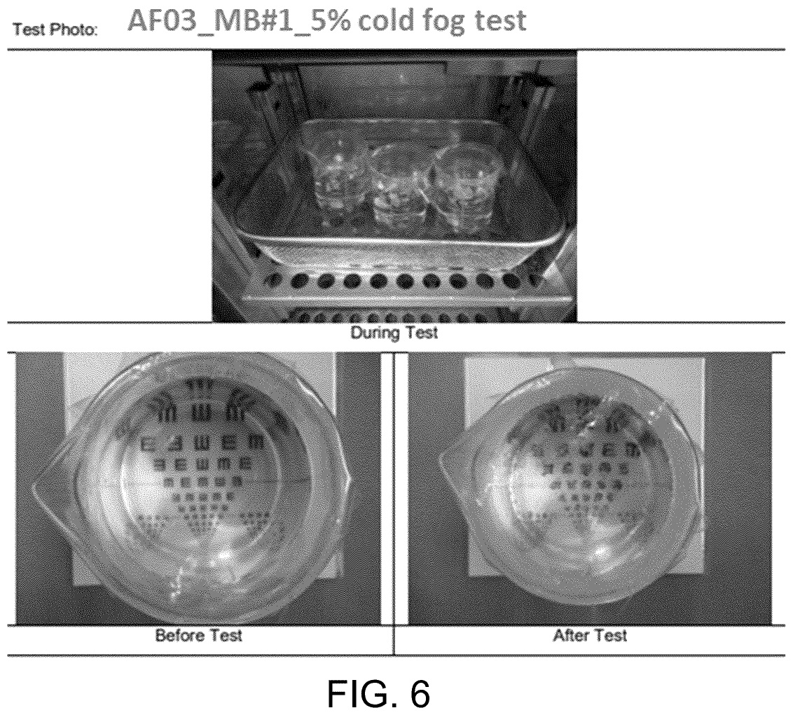

In addition, the AFPE plastic film AF03_MB #1_5% of the present disclosure was also subjected to a cold fog test. The general process and results are shown in FIG. 6. This AFPE plastic film exhibited anti-fogging property (G2) against cold fog after being placed at 3° C. for 5 minutes.

### Example 4: Transparency and Mechanical Properties Testing on AFPE Plastic Films

In this example, the light transmittance of a pure LDPE plastic film (control) and the AFPE plastic films AF08_MB #2_3% and AF08_MB #2_5% were characterized by a haze meter according to the industry standard GB/T 2410-2008, “Determination of the Luminous Transmittance and Haze of Transparent Plastics”. The tensile strength of these three plastic films were tested according to the industry standard ASTM D638, “Standard Test Method for Tensile Properties of Plastics”. The results are shown in Table 4 below.

TABLE 4
The test results of the light transmittance and tensile strength of AFPE plastic films

| | Transmittance | Transmittance | Tensile Strength | Tensile Strength |
|---|---|---|---|---|
| AFPE film ID | (%) | Retention (%) | at Break (MPa) | Retention (%)(n = 5) |
| Control LDPE | 90.9 ± 0.7 (n = 3) | — | 20.9 ± 1.8(n = 5) | |
| AF08_MB#2_3% | 91.5 ± 0.4 (n = 3) | 100.7(n = 3) | 22.8 ± 3.0(n = 5) | 109.1(n = 5) |
| AF08_MB#2_5% | 91.7 ± 0.4 (n = 3) | 100.9 (n = 3) | 21.7 ± 1.6(n = 5) | 103.8(n = 5) |

As can be seen from Table 4, the AFPE plastic films AF08_MB #B_3% and AF08_MB #B_5% of the present disclosure exhibited superior light transmittance compared to the pure LDPE plastic film, which indicates that the addition of the anti-fogging masterbatch pellets of the present disclosure does not affect the transparency of the PE films. Also, the tensile strength of both AFPE plastic films AF08_MB #B_3% and AF08_MB #B_5% of the present disclosure were improved, which may be due to the introduction of the elastomer SEBS with good mechanical properties.

### Example 5: Bacteria-Repellent Test on AFPE Films

In this example, a bacteria-repellent test according to Industrial standard ASTM E3371-22 was conducted on a pure LDPE plastic film (control) and the AFPE plastic film AF08_MB #2_5%, respectively. Particularly, the process was conducted as follows. Firstly, the AFPE plastic film sample was prepared and placed in a petri dish. Bacteria were incubated at the same time. Bacteria inoculum was taken and placed on the AFPE film sample, and the petri dish was placed with a covering film and incubated in a 37° C. incubator for 24 hours. Then, the covering film was removed and the AFPE film sample was washed slightly with saline. Bacteria on the AFPE film sample were collected by sonication and were incubated in an agar plate. After 24 hours, the anti-bacterial adhesion (by bacterial reduction) was determined.

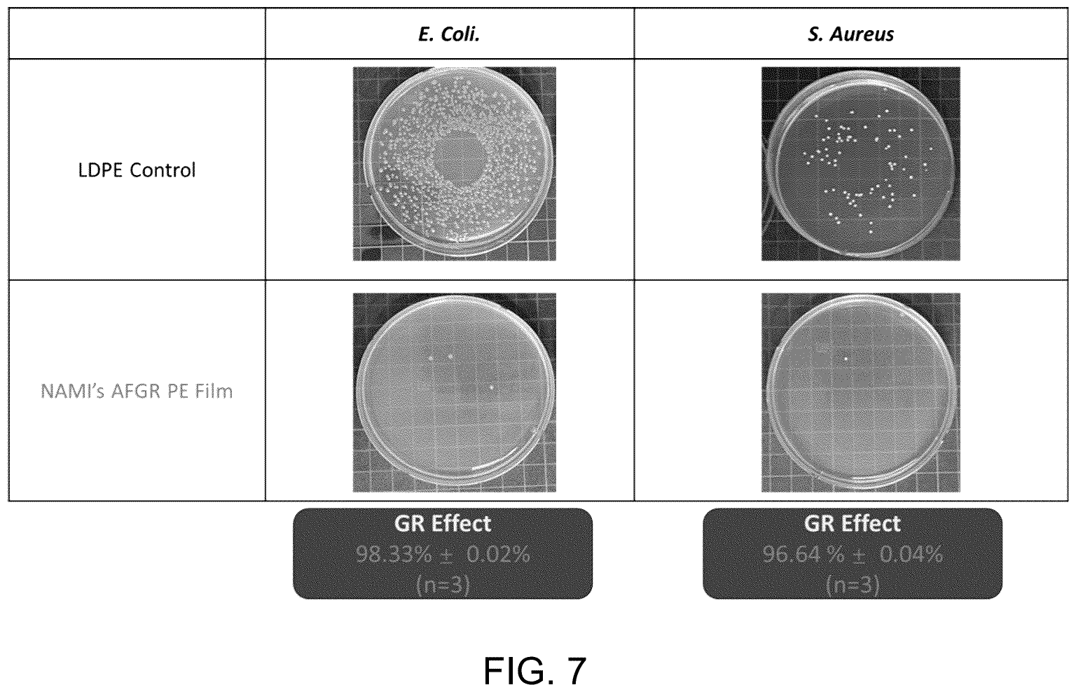

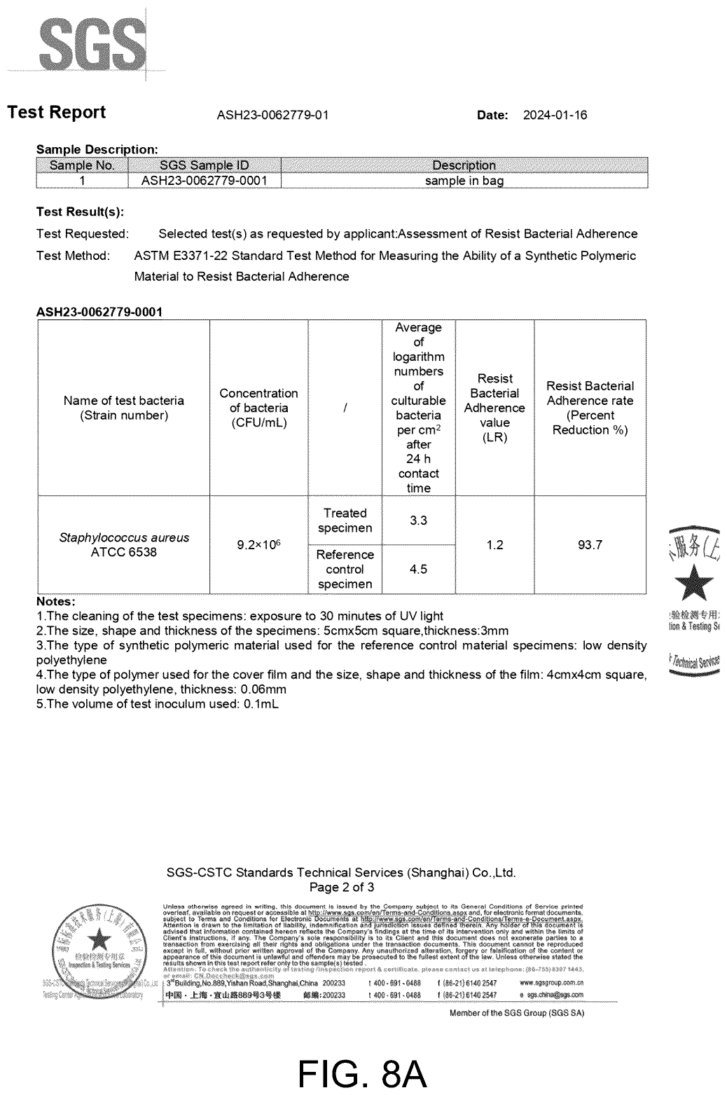

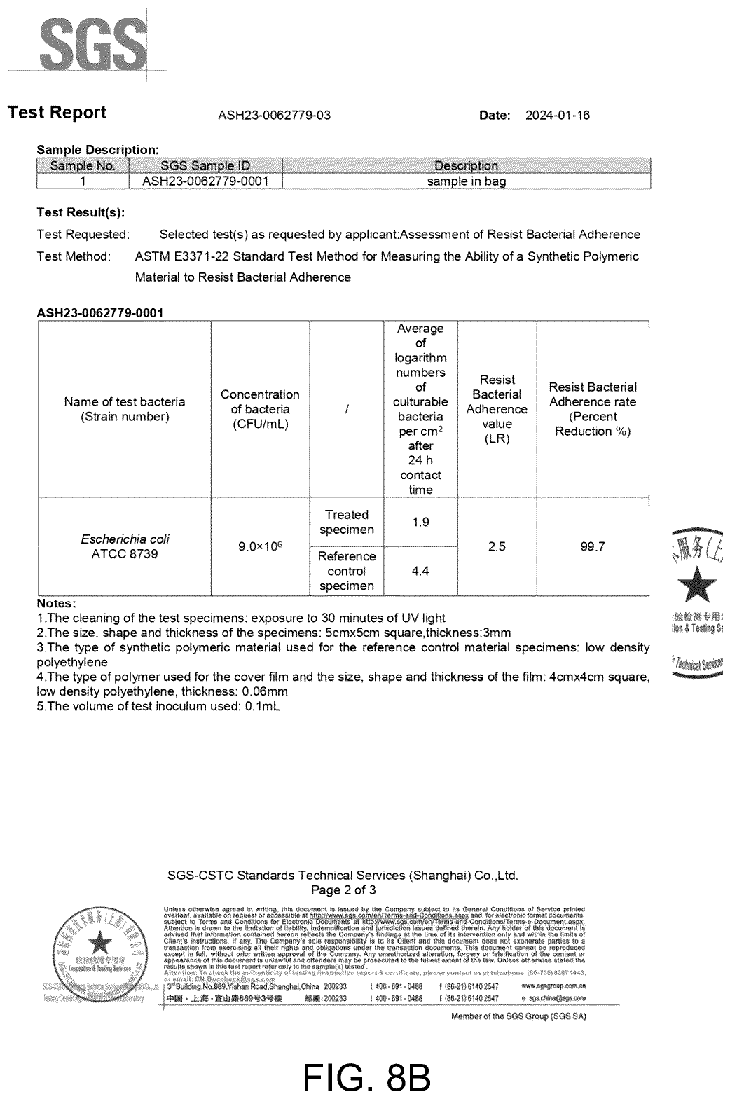

The results, as shown in FIG. 7 and FIGS. 8A-8B, show that the AFPE plastic film AF08_MB #2_5% of the present disclosure has significant bacteria-repellency against both E. coli and S. aureus as compared to the LDPE film (control), with bacterial reduction of 98.33%±0.02% for E. coli and 96.64%±0.04% for S. aureus.

### Example 6: Food Contact Safety Assessment

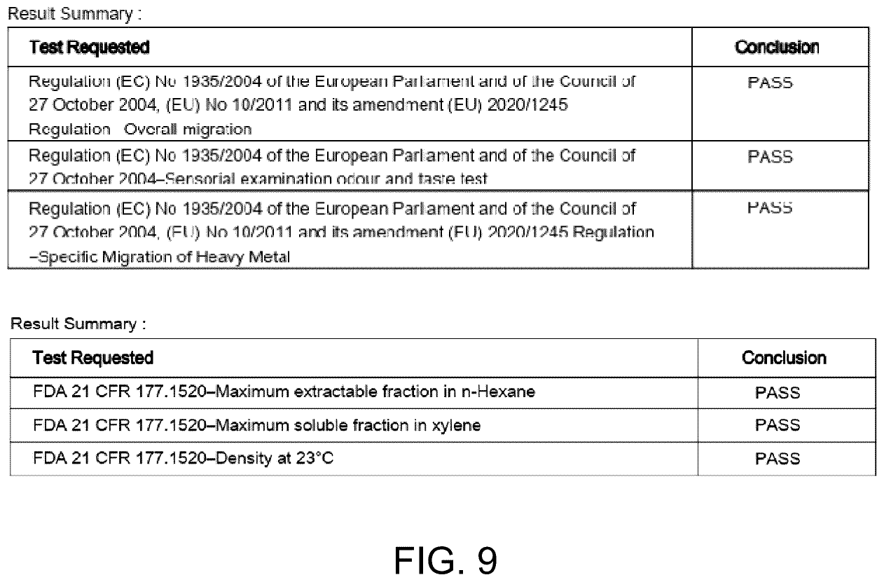

In this example, a food contact safety assessment was performed according to FDA and EU regulations. Particularly, the AFPE plastic film AF08_MB #2_5% of the present disclosure was placed in different simulated solutions (3% acetic acid solution, 10% ethanol solution, 95% ethanol solution) and was subjected to a simulated leaching experiment at a fixed test temperature (40° C.), and the mobility of the components specified in the safety assessment was calculated. As can be seen in FIG. 9, the AFPE plastic film AF08_MB #2_5% of the present disclosure passed the food contact safety assessment conducted by SGS in accordance with FDA and EU regulations.

### Example 7: Preparation of the Anti-Fogging Composition Comprising Two Anti-Fogging Agents and Related Tests

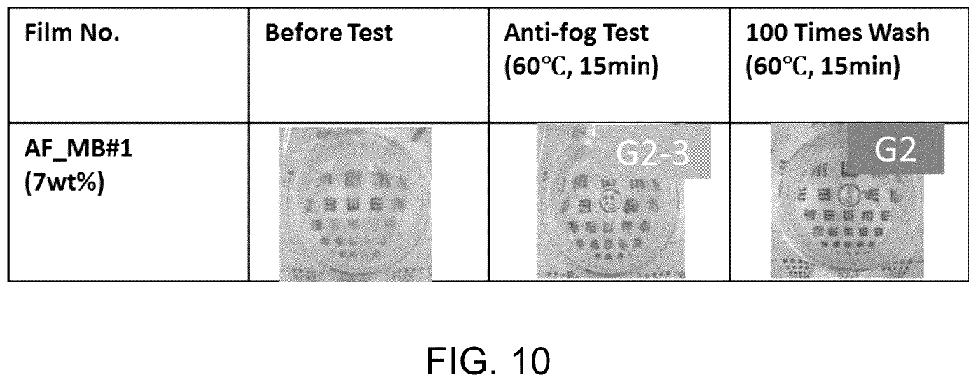

The anti-fogging polyethylene (AFPE) plastic film was prepared by blown-film extrusion method using low density polyethylene resin (LDPE) and the anti-fogging masterbatch AF_MB #1 comprising two anti-fogging agents prepared in Example 2 at a weight ratio of 93%:7%. The as-prepared plastic film was subject to a hot fog test by the water bath according to the industrial standard GB/T 31726 “Test Methods for Anti-fogging Properties of Plastic Films”. It was found that the anti-fogging film AF_MB #1_7% could achieve instant anti-fogging effect (G2-G3), and maintain an antifogging effect (G2) in the hot fog test after 100 times of water washings, showing washability. The details are shown in FIG. 10. The 100-time washings washed away the excessive anti-fog agents on the surface of plastic films. It made the distribution of water layer on the plastic films more uniform. Therefore, the anti-fog grade after 100time washings improved from G2-G3 to G2. In addition, the AFPE plastic film prepared by this formula had a tensile strength at break of 22.8±1.8 MPa (n=5), a transparency of 89.3±0.5 (n=3), and a haze of 20.7±0.6 (n=3).

What is claimed is:

1. An anti-fogging composition comprising, based on a total weight of the anti-fogging composition:
30%-50% of a first thermoplastic resin;
10%-30% of at least one anti-fogging agent;
25%-40% of a thermoplastic elastomer; and
0-10% of a porous copolymer carrier.

2. The anti-fogging composition according to claim 1, comprising, based on the total weight of the anti-fogging composition:
35%-45% of the first thermoplastic resin;
15%-30% of the at least one anti-fogging agent;
30%-35% of the thermoplastic elastomer; and
3%-7% of the porous copolymer carrier.

3. The anti-fogging composition according to claim 1, wherein the first thermoplastic resin is one or more selected from a group consisting of polyethylene (PE), polypropylene (PP), Ethylene Vinyl Acetate (EVA) and polyvinyl chloride (PVC).

4. The anti-fogging composition according to claim 3, wherein the first thermoplastic resin is polyethylene (PE) or low-density polyethylene (LDPE).

5. The anti-fogging composition according to claim 1, wherein the at least one anti-fogging agent is an amphipathic compound with multiple-OH end groups and a long-chain hydrophobic aliphatic group.

6. The anti-fogging composition according to claim 5, wherein the at least one anti-fogging agent is selected from a group consisting of fatty glyceride; fatty alcohol polyoxyethylene ether; alcohol oleate; sorbitan monostearate; polyether oligomer.

7. The anti-fogging composition according to claim 6, wherein the fatty glyceride is glyceryl stearate or glycerol monooleate, the fatty alcohol polyoxyethylene ether is polyoxyethylene lauryl ether, and the polyether oligomer is propylene glycol, polyethylene glycol, or octadecyldiethanolamine.

8. The anti-fogging composition according to claim 6, wherein the at least one anti-fogging agent is fatty glyceride and/or fatty alcohol polyoxyethylene ether.

9. The anti-fogging composition according to claim 6, wherein the at least one anti-fogging agent is the amphipathic compound of formula I or II:

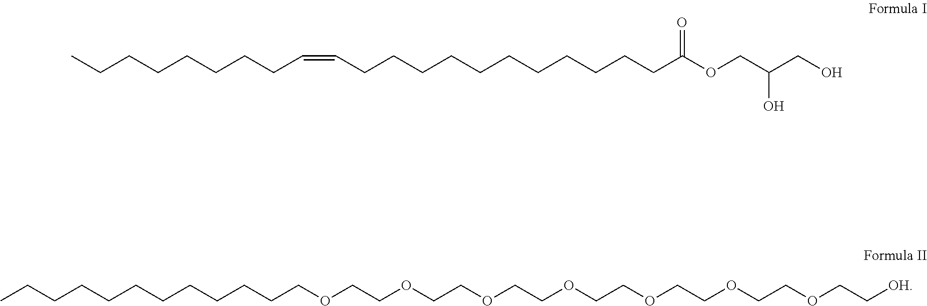 [SMILES: CCCCCCCC/C=C\CCCCCCCCCCCC(=O)OCC(O)CO ; CCCCCCCCCCCCOCCOCCOCCOCCOCCOCCOCCO]

10. The anti-fogging composition according to claim 1, wherein the at least one anti-fogging agent is a combination of two or more anti-fogging agents.

11. The anti-fogging composition according to claim 10, wherein the at least one anti-fogging agent is a combination of fatty glyceride and fatty alcohol polyoxyethylene ether.

12. The anti-fogging composition according to claim 1, wherein the thermoplastic elastomer is selected from a group consisting of Ethylene-octene copolymer (POE), Ethylene-propene-diolefin copolymer (EPDM), Styrene-butadiene-styrene block copolymer (SBS), Styrene-ethylene-butylene-styrene block copolymer (SEBS), Styrene-ethylene-propylene block copolymer-styrene (SEPS).

13. The anti-fogging composition according to claim 1, wherein the porous copolymer carrier is selected from a group consisting of an ethylene butyl acrylate (EBA) based porous copolymer carrier, a linear low-density polyethylene (LLDPE) based porous copolymer carriers, and a low-density polyethylene (LDPE) based porous copolymer carrier.

14. The anti-fogging composition according to claim 1, wherein the anti-fogging composition is prepared by mixing the first thermoplastic resin, the at least one anti-fogging agent, the thermoplastic elastomer and the porous copolymer carrier at a defined weight ratio and extruding through a twin-screw extruder.

15. The anti-fogging composition according to claim 1, wherein the anti-fogging composition is in a form of anti-fogging masterbatch.

16. An anti-fogging plastic prepared from the anti-fogging composition according to claim 1 and a second thermoplastic resin.

17. The anti-fogging plastic according to claim 16, wherein the anti-fogging composition is added in an amount from 1% to 10%, 3% to 8%, or 3% to 5%, based on the total weight of the anti-fogging plastic.

18. The anti-fogging plastic according to claim 16, wherein the anti-fogging composition exhibits a surface bacteria-repellent effect against bacterial adhesion with bacterial repellency of greater than 90%.

19. The anti-fogging plastic according to claim 16, wherein the second thermoplastic resin is selected from a group consisting of polyethylene (PE), polypropylene (PP), Ethylene Vinyl Acetate (EVA) and polyvinyl chloride (PVC).

20. The anti-fogging plastic according to claim 16, wherein the second thermoplastic resin is polyethylene (PE).

21. The anti-fogging plastic according to claim 16, wherein the second thermoplastic resin is the same as the first thermoplastic resin.
